(19) United States
(12) Patent Application Publication
(10) Pub. No.: US 2026/0367373 A1
(43) Pub. Date: Nov. 19, 2026

(54) VISION SYSTEM

(71) Applicant: ZHEJIANG SUNNY OPTICS CO., LTD., Zhejiang (CN)

(72) Inventors: LINWEI WU, Zhejiang (CN); XIAOBIN ZHANG, Zhejiang (CN); LIN HUANG, Zhejiang (CN); YINFANG JIN, Zhejiang (CN)

(21) Appl. No.: 19/338,232

(22) Filed: Sep. 24, 2025

(30) Foreign Application Priority Data
May 19, 2025 (CN) 202510644872.X

(51) Int. Cl. G02B 17/08

(52) U.S. Cl. CPC G02B 17/0856

(57) ABSTRACT

A vision system includes a first element group and a second element group sequentially from a first side to a second side of the vision system along an optical axis of the vision system. A radius of curvature R3 of a first side surface of a second lens, a radius of curvature R4 of a second side surface of the second lens, and a combined focal length fz of a first lens, a polarizer, a reflective polarization element and a quarter wave plate satisfy: 0.8<(R3+R4)/fz<1.9; and a central thickness CT2 of the second lens on the optical axis, and a distance ΔL, travelled by the second element group along the optical axis when an optical power of the vision system is changed from +2 D to −5 D, satisfy: 2.0<CT2/ΔL<3.7.

### CROSS-REFERENCE TO RELATED APPLICATION AND CLAIM OF PRIORITY

This application claims the benefit under 35 USC § 119 of Chinese Patent Application No. 202510644872.X, filed on May 19, 2025, in the China Intellectual Property Office, the entire disclosure of which is incorporated herein by reference for all purposes.

### BACKGROUND

### 1. Technical Field

The present disclosure relates to the technical field of head-mounted display devices, and specifically relates to a vision system.

### 2. Background Art

In the existing head-mounted display devices, most vision systems are designed only for users with −1.00 D myopia, while people with other degrees of myopia or hyperopia have to wear myopic or hyperopic glasses in addition to the head-mounted display device to obtain a relatively good experience. Wearing the head-mounted display device and glasses simultaneously may additionally burden both sides of the user's nose bridge, resulting in an uncomfortable wearing experience. In other words, the existing vision systems have the problem of insufficient adjustment of optical power, and cannot provide a sufficient adjusting range of optical power, particularly for users with significant vision differences from normal users, such as myopic and hyperopic users. Meanwhile, to adapt the optical power adjustment, the limit design of the lens shape causes poor processability, aggravates the surface type sensitivity of the vision system, and thus is not favorable for maintaining the optical performance. Therefore, to achieve a wider adjusting range of optical power while reducing the lens surface type sensitivity, how to adjust the size and optical parameters of the lens barrel and optical elements of the vision system has become a very important issue to address.

### SUMMARY

A main object of the present disclosure is to provide a vision system which can solve the problem that it is hard to balance the wide adjusting range of optical power and the low lens surface type sensitivity of a vision system in the existing art.

To achieve the above object, according to one aspect of the present disclosure, there is provided a vision system, sequentially including, from a first side to a second side along an optical axis of the vision system: a first element group including, from the first side to the second side along the optical axis, at least a first lens, a polarizer, a reflective polarization element, and a quarter wave plate, wherein the first lens has a positive power, a first side surface of the first lens is convex, and a second side surface of the first lens is planar; and a second element group movable in a direction of the optical axis to approach or get away from the first element group, wherein the second element group includes, from the first side to the second side along the optical axis, at least a second lens, a partially reflective element, and a display, the second lens has a positive power, a first side surface of the second lens is convex, and a second side surface of the second lens is convex; wherein a radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and a central thickness CT2 of the second lens on the optical axis, and a distance ΔL, travelled by the second element group along the optical axis when an optical power of the vision system is changed from +2 D to −5 D, satisfy: 2.0<CT2/ΔL<3.7.

According to a further aspect of the present disclosure, there is provided a vision system, sequentially including, from a first side to a second side along an optical axis of the vision system: a first element group including, from the first side to the second side along the optical axis, at least a first lens, a polarizer, a reflective polarization element, and a quarter wave plate, wherein the first lens has a positive power, a first side surface of the first lens is convex, and a second side surface of the first lens is planar; and a second element group movable in a direction of the optical axis to approach or get away from the first element group, wherein the second element group includes, from the first side to the second side along the optical axis, at least a second lens, a partially reflective element, and a display, the second lens has a positive power, a first side surface of the second lens is convex, and a second side surface of the second lens is convex; wherein a radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and a central thickness CT1 of the first lens on the optical axis, a central thickness CTL of the polarizer on the optical axis, a central thickness CTR of the reflective polarization element on the optical axis, a central thickness CTQ of the quarter wave plate on the optical axis, and a variation Δf of an effective focal length of the vision system when the optical power of the vision system changes from +2 D to −5 D satisfy: 3.40≤(CT1+CTL+CTR+CTQ)/Δf≤4.07.

Further, a central thickness CT1 of the first lens on the optical axis, a central thickness CTL of the polarizer on the optical axis, a central thickness CTR of the reflective polarization element on the optical axis, a central thickness CTQ of the quarter wave plate on the optical axis, and a variation Δf of an effective focal length of the vision system when the optical power of the vision system changes from +2 D to −5 D satisfy: 3.40≤(CT1+CTL+CTR+CTQ)/Δf<4.07.

Further, a radius of curvature R1 of the first side surface of the first lens, and a distance TDm on the optical axis from the first side surface of the first lens to the second side surface of the second lens when the optical power of the vision system is +2 D satisfy: 3.47≤R1/TDm≤4.12.

Further, an effective focal length f2 of the second lens, a distance T12m on the optical axis from the second side surface of the first lens to the first side surface of the second lens when the optical power of the vision system is +2 D, and a distance T12n on the optical axis from the second side surface of the first lens to the first side surface of the second lens when the optical power of the vision system is −5 D satisfy: 8.11≤f2/(T12m+T12n)≤12.64.

Further, an effective focal length f1 of the first lens, an effective focal length fm of the vision system when the optical power of the vision system is +2 D, and an effective focal length fm of the vision system when the optical power of the vision system is −5 D satisfy: 2.35<f1/(fm+fn)<2.75.

Further, a variation Δf of an effective focal length of the vision system when the optical power of the vision system changes from +2 D to −5 D, and a distance BFL on the optical axis from the second side surface of the second lens to the display satisfy: 1.15<Δf/BFL<1.55.

Further, a distance TDn on the optical axis from the first side surface of the first lens to the second side surface of the second lens when the optical power of the vision system is −5 D, and a distance T12n on the optical axis from the second side surface of the first lens to the first side surface of the second lens when the optical power of the vision system is −5 D satisfy: 2.40≤TDn/T12n≤3.83.

Further, an effective focal length f2 of the second lens, an Abbe number V2 of the second lens, and a variation Δf of an effective focal length of the vision system when the optical power of the vision system changes from +2 D to −5 D satisfy: 1.76≤(f2/V2)/Δf≤2.09.

Further, a distance ΔL travelled by the second element group along the optical axis when an optical power of the vision system is changed from +2 D to −5 D, a refractive index N2 of the second lens, and a refractive index N1 of the first lens satisfy: 2.14 mm≤ΔL×(N2/N1)≤2.45 mm.

Further, a distance TDn on the optical axis from the first side surface of the first lens to the second side surface of the second lens when the optical power of the vision system is −5 D, an effective focal length f1 of the first lens, and an Abbe number V1 of the first lens satisfy: 6.54≤TDn/(f1/V1)≤7.87.

Further, a distance T12m on the optical axis from the second side surface of the first lens to the first side surface of the second lens when the optical power of the vision system is +2 D, a distance T12n on the optical axis from the second side surface of the first lens to the first side surface of the second lens when the optical power of the vision system is −5 D, and an entrance pupil diameter EPD of the vision system satisfy: 2.74≤(T12m+T12n)/EPD≤4.08.

Further, a distance ΔL travelled by the second element group along the optical axis when an optical power of the vision system is changed from +2 D to −5 D, a radius of curvature R3 of the first side surface of the second lens, and a radius of curvature R4 of the second side surface of the second lens satisfy: −8.21 mm≤ΔL×(R3/R4)≤−4.96 mm.

Further, a variation Δf of an effective focal length of the vision system when the optical power of the vision system changes from +2 D to −5 D, an effective focal length f2 of the second lens, and a combined focal length fz of the first lens, the polarizer, the reflective polarization element and the quarter wave plate satisfy: 1.2 mm<Δf×(f2/fz)<1.5 mm.

Further, a central thickness CT1 of the first lens on the optical axis, a central thickness CT2 of the second lens on the optical axis, and a distance T12m on the optical axis from the second side surface of the first lens to the first side surface of the second lens when the optical power of the vision system is +2 D satisfy: 1.04≤(CT1+CT2)/T12m≤1.91.

According to the technical solution of the present disclosure, the vision system sequentially includes, from a first side to a second side along an optical axis of the vision system, a first element group and a second element group, where the first element group includes, from the first side to the second side along the optical axis, at least a first lens, a polarizer, a reflective polarization element, and a quarter wave plate, the first lens has a positive power, a first side surface of the first lens is convex, and a second side surface of the first lens is planar; and the second element group is movable in a direction of the optical axis to approach or get away from the first element group, the second element group includes, from the first side to the second side along the optical axis, at least a second lens, a partially reflective element, and a display, the second lens has a positive power, a first side surface of the second lens is convex, and a second side surface of the second lens is convex; where a radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and a central thickness CT2 of the second lens on the optical axis, and a distance ΔL, travelled by the second element group along the optical axis when an optical power of the vision system is changed from +2 D to −5 D, satisfy: 2.0<CT2/ΔL<3.7.

The vision system of the present application is provided with a first element group including at least a first lens, a polarizer, a reflective polarization element, and a quarter wave plate, and a second element group including a second lens, a partially reflective element, and a display, where the second element group is movable along a direction of the optical axis as a whole, and the display is provided at a fixed position relative to the partially reflective element, thereby implementing optical power adjustment of the vision system. By reasonably configuring a combined focal length of the first lens, the polarizer, the reflective polarization element and the quarter wave plate, a radius of curvature and a central thickness of the second lens, and a moving distance of the second element group, a refraction effect of second lens can be balanced while controlling a total length of the vision system, the optimization space for optical power adjustment is increased, and the vision system is ensured to allow a change in optical power from −5 D to +2 D, thereby improving the wearing comfort of users with different degrees of vision. Meanwhile, distortion degrees of the first and second lenses can be indirectly controlled, so that an edge-thickness ratio of each lens can be further controlled and the processability is improved, while the surface type sensitivity of the vision system is reduced to maintain stable optical performance of the vision system.

### BRIEF DESCRIPTION OF THE DRAWINGS

The accompanying drawings, which constitute a part of the present application, are illustrated here to provide a further understanding of the present disclosure, and exemplary embodiments of the present disclosure and description thereof serve to explain the present disclosure instead of limiting the present disclosure inappropriately. In the drawings:

FIGS. 1 to 2 are schematic structural diagrams of a vision system according to a first embodiment of the present disclosure in a first state and a second state, respectively;

FIGS. 3 to 4 are MTF graphs of the vision system according to the first embodiment of the present disclosure in the first state and the second state, respectively;

FIGS. 5 to 6 are schematic structural diagrams of a vision system according to a second embodiment of the present disclosure in a first state and a second state, respectively;

FIGS. 7 to 8 are MTF graphs of the vision system according to the second embodiment of the present disclosure in the first state and the second state, respectively;

FIGS. 9 to 10 are schematic structural diagrams of a vision system according to a third embodiment of the present disclosure in a first state and a second state, respectively;

FIGS. 11 to 12 are MTF graphs of the vision system according to the third embodiment of the present disclosure in the first state and the second state, respectively;

FIGS. 13 to 14 are schematic structural diagrams of a vision system according to a fourth embodiment of the present disclosure in a first state and a second state, respectively; and

FIGS. 15 to 16 are MTF graphs of the vision system according to the fourth embodiment of the present disclosure in the first state and the second state, respectively.

Reference signs in the drawings are listed below:
G1, first element group; G2, second element group; STO, stop; E1, first lens; LP, polarizer; RP, reflective polarization element; QWP, quarter wave plate; E2, second lens; BS, partially reflective element; and IMG, image plane.

### DETAILED DESCRIPTION OF THE INVENTION

It should be noted that the embodiments of the present application and features therein may be combined with each other as long as they are not contradictory. The present disclosure will be described in detail below with reference to the accompanying drawings in conjunction with embodiments.

It is to be noted that, unless defined otherwise, all technical and scientific terms used herein have the same meaning as commonly understood by one of ordinary skill in the art to which this application belongs.

In the present disclosure, unless stated to the contrary, the use of directional terms such as “upper, lower, top, bottom” or the like, generally refers to the orientation of the components as shown in the drawings, or to the vertical, perpendicular, or gravitational orientation of the components themselves; likewise, for ease of understanding and description, “inside and outside” refer to inside and outside relative to a contour of the components themselves, but the above directional terms are not intended to limit the present disclosure.

It should be noted that in this specification, the expressions first, second, third, and the like are only used to distinguish one feature from another, and do not represent any limitation to the features. Therefore, the first lens discussed below may also be referred to as the second lens or the third lens without departing from the teachings of the present application.

In the drawings, the thicknesses, sizes and shapes of the lenses have been slightly exaggerated for the convenience of explanation. Specifically, the shapes of the spherical or aspherical surfaces shown in the drawings are shown by way of example. That is, the shape of the spherical or aspherical surface is not limited to those shown in the drawings. The figures are merely exemplary and not drawn to scale.

Herein, the paraxial region refers to a region near the optical axis. If a lens surface is convex and the convex position is not defined, it means that the lens surface is convex at least in the paraxial region; and if a lens surface is concave and the concave position is not defined, it means that the lens surface is concave at least in the paraxial region. The determination of the surface type in the paraxial region may be performed in a method known to a person of ordinary skill in the art, i.e., by determining whether the surface is concave or convex by an R value (which represents a radius of curvature in the paraxial region, and usually denotes an R value in lens data in optical software). From the perspective of an eye-side surface, when the R value is positive, it is determined that the surface is convex, and when the R value is negative, it is determined that the surface is concave. From the perspective of a display-side surface, when the R value is positive, it is determined that the surface is concave, and when the R value is negative, it is determined that the surface is convex.

To solve the problem that it is hard to balance the wide adjusting range of optical power and the low lens surface type sensitivity of a vision system in the existing art, the present disclosure provides a vision system.

### First Implementation

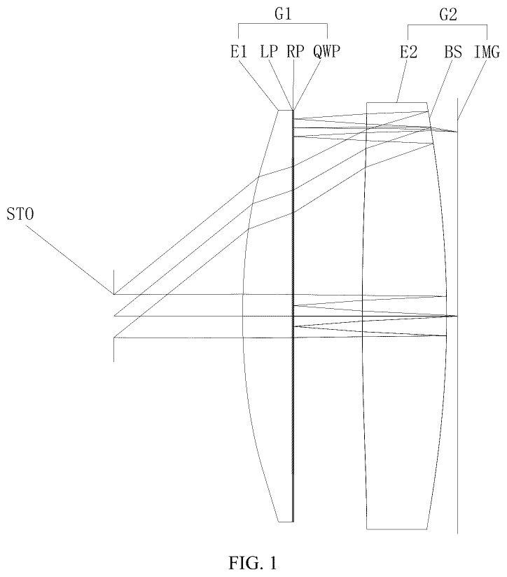

As shown in FIGS. 1 to 16, the vision system sequentially includes, from a first side to a second side along an optical axis of the vision system, a first element group and a second element group, where the first element group includes, from the first side to the second side along the optical axis, at least a first lens, a polarizer, a reflective polarization element, and a quarter wave plate. The first lens has a positive power, a first side surface of the first lens is convex, and a second side surface of the first lens is planar. The second element group is movable in a direction of the optical axis to approach or get away from the first element group. The second element group includes, from the first side to the second side along the optical axis, at least a second lens, a partially reflective element, and a display. The second lens has a positive power, a first side surface of the second lens is convex, and a second side surface of the second lens is convex. A radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and a central thickness CT2 of the second lens on the optical axis, and a distance ΔL, travelled by the second element group along the optical axis when an optical power of the vision system is changed from +2 D to −5 D, satisfy: 2.0<CT2/ΔL<3.7.

The vision system of the present application is provided with a first element group including at least a first lens, a polarizer, a reflective polarization element, and a quarter wave plate, and a second element group including a second lens, a partially reflective element, and a display, where the second element group is movable along a direction of the optical axis as a whole, and the display is provided at a fixed position relative to the partially reflective element, thereby implementing optical power adjustment of the vision system. By reasonably configuring a combined focal length of the first lens, the polarizer, the reflective polarization element and the quarter wave plate, a radius of curvature and a central thickness of the second lens, and a moving distance of the second element group, a refraction effect of second lens can be balanced while controlling a total length of the vision system, so that the optimization space for optical power adjustment is increased, and the vision system is ensured to allow a change in optical power from −5 D to +2 D, thereby improving the wearing comfort of users with different degrees of vision. Meanwhile, distortion degrees of the first and second lenses can be indirectly controlled, so that an edge-thickness ratio of each lens can be further controlled and the processability is improved, while the surface type sensitivity of the vision system is reduced to maintain stable optical performance of the vision system.

In this implementation, a central thickness CT1 of the first lens on the optical axis, a central thickness CTL of the polarizer on the optical axis, a central thickness CTR of the reflective polarization element on the optical axis, a central thickness CTQ of the quarter wave plate on the optical axis, and a variation Δf of an effective focal length of the vision system when the optical power of the vision system changes from +2 D to −5 D satisfy: 3.40<(CT1+CTL+CTR+CTQ)/Δf≤4.07. By limiting (CT1+CTL+CTR+CTQ)/Δf within a reasonable range, a too large adjustment space of the second element group in the optical power adjusting process can be avoided, and the bearing feeling of the user head during optical power adjustment is alleviated, which can help to keep a stable line of sight of the user, and enable comfortable watching experience of the user.

In this implementation, a radius of curvature R1 of the first side surface of the first lens, and a distance TDm on the optical axis from the first side surface of the first lens to the second side surface of the second lens when the optical power of the vision system is +2 D satisfy: 3.47≤R1/TDm≤4.12. By limiting R1/TDm within a reasonable range, smoothness of the first lens can be improved to reduce the surface roughness and single-side eccentricity sensitivity of the vision system, and further reduce a performance difference between a theoretical value and a design value caused by the process, so that a too large distance from the first side surface of the first lens to the second side surface of the second lens on the optical axis is avoided when the optical power of the vision system is +2 D, thereby alleviating the bearing feeling of the nose bridge of the user and enhancing the immersive watching feeling of the user.

In this implementation, an effective focal length f2 of the second lens, a distance T12m on the optical axis from the second side surface of the first lens to the first side surface of the second lens when the optical power of the vision system is +2 D, and a distance T12n on the optical axis from the second side surface of the first lens to the first side surface of the second lens when the optical power of the vision system is −5 D satisfy: 8.11≤f2/(T12m+T12n)≤12.64. By limiting f2/(T12m+T12n) within a reasonable range, the optical path and the total optical length of the vision system can be further shortened, which can facilitate high integration of the vision system so that the image plane is highly consistent with the ideal image plane, and higher imaging definition and resolution can be obtained. Meanwhile, the restriction to the range of f2/(T12m+T12n) can further reduce eye fatigue of the user when the user wears the head-mounted display device for a long time and improve the wearing comfort, so that the user can wear the head-mounted display device for a prolonged time.

In this implementation, an effective focal length f1 of the first lens, an effective focal length fm of the vision system when the optical power of the vision system is +2 D, and an effective focal length fm of the vision system when the optical power of the vision system is −5 D satisfy: 2.35<f1/(fm+fn)<2.75. By limiting f1/(fm+fn) within a reasonable range, the bending effect on light can be distributed between the first and second element groups in a relatively uniform manner, to restrict a propagation range of light, reduce the scattered and interference light in the vision system, and improve the resolution, contrast, color reproduction, and overall imaging quality of the vision system. In addition, the restriction to the range of f2/(T12m+T12n) can improve the imaging definition and color expression in a virtual environment, significantly improve the visual effect, and enhance the watching experience of the user.

In this implementation, a variation Δf of an effective focal length of the vision system when the optical power of the vision system changes from +2 D to −5 D, and a distance BFL on the optical axis from the second side surface of the second lens to the display satisfy: 1.15<Δf/BFL<1.55. By limiting Δf/BFL within a reasonable range, significant changes in the gravity center of the vision system can be avoided during adjustment of the optical power, and a user can be kept free from the influences of external interference or body movement, so that a stable line of sight of the user can be kept, and a better visual effect and a more comfortable watching experience can be obtained.

In this implementation, a distance TDn on the optical axis from the first side surface of the first lens to the second side surface of the second lens when the optical power of the vision system is −5 D, and a distance T12n on the optical axis from the second side surface of the first lens to the first side surface of the second lens when the optical power of the vision system is −5 D satisfy: 2.40≤TDn/T12n≤3.83. By limiting TDn/T12n within a reasonable range, the size and weight of the vision system can be effectively controlled so that the system has a more compact structure which is suitable for integration, and the propagation of light in air can be effectively limited to reduce the scattered and interference light in the vision system, and improve the resolution, contrast, color reproduction, and overall imaging quality of the vision system.

In this implementation, an effective focal length f2 of the second lens, an Abbe number V2 of the second lens, and a variation Δf of an effective focal length of the vision system when the optical power of the vision system changes from +2 D to −5 D satisfy: 1.76≤(f2/V2)/Δf≤2.09. By limiting (f2/V2)/Δf within a reasonable range, the dispersion effect of the vision system can be reduced to avoid chromatic aberration and improve the imaging quality of the vision system. Meanwhile, the restriction to the range of (f2/V2)/Δf can increase the adjustment flexibility of the vision system to make it further adapt to different working environments and requirements.

In this implementation, a distance ΔL travelled by the second element group along the optical axis when an optical power of the vision system is changed from +2 D to −5 D, a refractive index N2 of the second lens, and a refractive index N1 of the first lens satisfy: 2.14 mm≤ΔL×(N2/N1)≤2.45 mm. By limiting ΔL×(N2/N1) within a reasonable range, the direction of light refraction can be controlled to effectively reduce the stress and the risk of ghost images in the vision system, and the lens design is simplified to reduce the requirement for complex dispersion compensation, thereby reducing the overall complexity of the vision system. Meanwhile, the restriction to the range of ΔL×(N2/N1) can maintain more stable optical performance, reduce performance fluctuations of the vision system due to differences in material and refractive index of the first lens and the second lens, and increase stability and reliability of the vision system.

In this implementation, a distance TDn on the optical axis from the first side surface of the first lens to the second side surface of the second lens when the optical power of the vision system is −5 D, an effective focal length f1 of the first lens, and an Abbe number V1 of the first lens satisfy: 6.54≤TDn/(f1/V1)≤7.87. By limiting TDn/(f1/V1) within a reasonable range, the design requirement of the vision system can be better met, and the performance and stability of the vision system can be improved; meanwhile, the energy efficiency of the vision system can be improved without increasing the cost, thereby reducing the resource consumption.

In this implementation, a distance T12m on the optical axis from the second side surface of the first lens to the first side surface of the second lens when the optical power of the vision system is +2 D, a distance T12n on the optical axis from the second side surface of the first lens to the first side surface of the second lens when the optical power of the vision system is −5 D, and an entrance pupil diameter EPD of the vision system satisfy: 2.74≤(T12m+T12n)/EPD≤4.08. By limiting (T12m+T12n)/EPD within a reasonable range, distortion and chromatic aberration generated by the first lens and the second lens can be reduced, and the imaging accuracy and reality can be improved. Meanwhile, the restriction to the range of (T12m+T12n)/EPD can improve the illumination uniformity of the vision system, avoid the problems of uneven brightness, glare and the like, and improve the user experience.

In this implementation, a distance ΔL travelled by the second element group along the optical axis when an optical power of the vision system is changed from +2 D to −5 D, a radius of curvature R3 of the first side surface of the second lens, and a radius of curvature R4 of the second side surface of the second lens satisfy: −8.21 mm≤ΔL×(R3/R4)≤−4.96 mm. By limiting ΔL×(R3/R4) within a reasonable range, the imaging quality of the vision system can be improved to reduce the aberration and improve the performance, and the volume and weight of the second element group can be further reduced so that the vision system can be more compact and lighter. Meanwhile, the material waste and the production cost can be reduced, the production efficiency can be improved, and the production cost can be reduced.

In this implementation, a variation Δf of an effective focal length of the vision system when the optical power of the vision system changes from +2 D to −5 D, an effective focal length f2 of the second lens, and a combined focal length fz of the first lens, the polarizer, the reflective polarization element and the quarter wave plate satisfy: 1.2 mm<Δf×(f2/fz)<1.5 mm. By limiting Δf×(f2/fz) within a reasonable range, the difference in vision of different users can be better adapted, a more customized visual experience can be provided, so that the vision system can be more suitable for a broader user base and wider application scenarios, and the competitiveness and applicability of a vision system are improved. Further, the depth-of-field effect of the vision system can be improved, and the sense of realism and immersion in the virtual environment are enhanced, so that a user can be immersed in the virtual world more easily.

In this implementation, a central thickness CT1 of the first lens on the optical axis, a central thickness CT2 of the second lens on the optical axis, and a distance T12m on the optical axis from the second side surface of the first lens to the first side surface of the second lens when the optical power of the vision system is +2 D satisfy: 1.04≤(CT1+CT2)/T12m≤1.91. By limiting (CT1+CT2)/T12m within a reasonable range, light convergence at a large field of view and miniaturization of the vision system are facilitated.

### Second Implementation

As shown in FIGS. 1 to 16, the vision system sequentially includes, from a first side to a second side along an optical axis of the vision system, a first element group and a second element group, where the first element group includes, from the first side to the second side along the optical axis, at least a first lens, a polarizer, a reflective polarization element, and a quarter wave plate. The first lens has a positive power, a first side surface of the first lens is convex, and a second side surface of the first lens is planar. The second element group is movable in a direction of the optical axis to approach or get away from the first element group. The second element group includes, from the first side to the second side along the optical axis, at least a second lens, a partially reflective element, and a display. The second lens has a positive power, a first side surface of the second lens is convex, and a second side surface of the second lens is convex. A radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and a central thickness CT1 of the first lens on the optical axis, a central thickness CTL of the polarizer on the optical axis, a central thickness CTR of the reflective polarization element on the optical axis, a central thickness CTQ of the quarter wave plate on the optical axis, and a variation Δf of an effective focal length of the vision system when the optical power of the vision system changes from +2 D to −5 D satisfy: 3.40≤(CT1+CTL+CTR+CTQ)/Δf≤4.07.

The vision system of the present application is provided with, along the optical axis, a first element group including at least a first lens, a polarizer, a reflective polarization element, and a quarter wave plate, and a second element group including a second lens, a partially reflective element, and a display, where the second element group is movable along a direction of the optical axis as a whole, and the display is provided at a fixed position relative to the partially reflective element, thereby implementing optical power adjustment of the vision system. By reasonably configuring a combined focal length of the first lens, the polarizer, the reflective polarization element and the quarter wave plate, a radius of curvature and a central thickness of the second lens, and a moving distance of the second element group, a refraction effect of second lens can be balanced while controlling a total length of the vision system, the optimization space for optical power adjustment is increased, and the vision system is ensured to allow a change in optical power from −5 D to +2 D. Meanwhile, a too large adjustment space of the second element group in the optical power adjusting process can be avoided, and the bearing feeling of the user head during optical power adjustment is alleviated, which can help to keep a stable line of sight of the user, and enable a comfortable wearing and watching experience of the user. Further, distortion degrees of the first and second lenses can be indirectly controlled, so that an edge-thickness ratio of each lens can be further controlled and the processability is improved, while the surface type sensitivity of the vision system is reduced to maintain stable optical performance of the vision system.

This implementation may further include other parametric representations in the first implementation, which are not repeated here.

In the present application, at least one of the first lens or the second lens has an aspherical lens surface. The aspherical lens is characterized in that: the lens has a curvature continuously varying from a center to a periphery of the lens. Unlike a spherical lens having a constant curvature from the center to the periphery of the lens, the aspherical lens has better radius of curvature characteristics, and has the advantage of improving distortion aberration and astigmatic aberration. When an aspherical lens is adopted, the aberration generated during imaging can be eliminated as much as possible, thereby improving the imaging quality.

However, it will be appreciated by those skilled in the art that the number of lenses forming the vision system can be varied to achieve the various results and advantages described in this specification without departing from the claimed technical solutions of the present application. For example, although the description has been given taking the case of two lenses as an example in the implementations, the vision system is not limited to including two lenses. The vision system may include other numbers of lenses, if desired.

It should be noted that the movement of the second element group in the vision system approaching or getting away from the first element group along the optical axis results in a change in optical power. The vision system has an optical power of +2 D in a first state, and an optical power of −5 D in a second state. In the first state, the vision system is adapted to a user with +2 D hyperopia, and in the second state, the vision system is adapted to a user with −5 D myopia. In addition to the first state and the second state, the vision system further includes other states in which the vision system has an optical power between +2 D and −5 D.

It should be noted that the first side refers to an eye side, the second side refers to a display side, and the image plane is located on the display.

Embodiments of specific surface types and parameters of a vision system that can be adapted to the above implementations are further described below with reference to the accompanying drawings.

It should be noted that any one of the first to fourth embodiments described below is applicable to all embodiments of the present application.

### First Embodiment

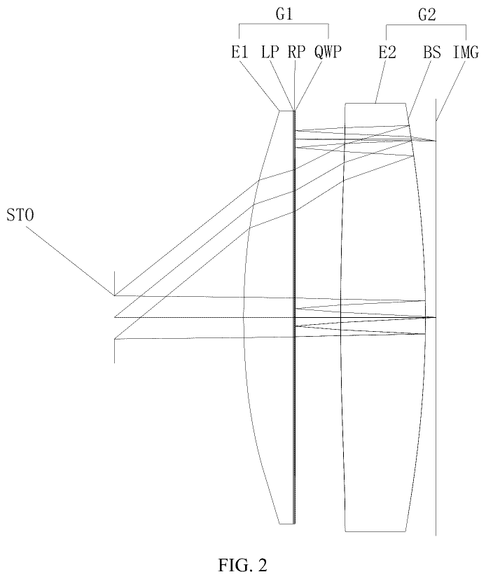

As shown in FIGS. 1 to 2, structures of a vision system according to the first embodiment of the present application in a first state and a second state are depicted, respectively.

As shown in FIGS. 1 to 2, the vision system sequentially includes, from a first side to a second side, a first element group G1 and a second element group G2. The first element group G1 includes a first lens E1, a polarizer LP, a reflective polarization element RP, and a quarter wave plate QWP, and the second element group G2 includes a second lens E2, a partially reflective element BS, and a display provided with an image plane IMG.

In this embodiment, the first lens has a positive power, a first side surface of the first lens is convex, and a second side surface of the first lens is planar, while the second lens has a positive power, a first side surface of the second lens is convex, and a second side surface of the second lens is convex. The vision system further has a stop STO between the first side and the first element group. A first side surface of the polarizer is at least partially attached to the second side surface of the first lens, a second side surface of the polarizer is attached to a first side surface of the reflective polarization element, a second side surface of the reflective polarization element is attached to a first side surface of the quarter wave plate, and a first side surface of the partially reflective element is at least partially attached to the second side surface of the second lens.

In this embodiment, light from the image plane IMG sequentially passes through the second lens E2 and the quarter wave plate QWP to the reflective polarization element RP, and after being reflected by the reflective polarization element RP, the light further passes through the quarter wave plate QWP and the second lens E2 sequentially to the partially reflective element BS on the second side surface of the second lens, where the light is reflected by the partially reflective element BS, and again passes through the second lens E2, the quarter wave plate QWP, the reflective polarization element RP, the polarizer LP, and the first lens E1 to be emitted.

Table 1 shows a table of basic structural parameters of the vision system in the first embodiment, in which radii of curvature, thicknesses/distances, and effective focal lengths are all provided in mm. In table 1, the light from the image plane IMG propagates from a plane 16 to a plane 1, and refraction/reflection indicates that the light is refracted or reflected by the corresponding numbered plane.

TABLE 1

| Surface | | | Radius of | | Refractive | Abbe | Refraction/ | Conic |
|---|---|---|---|---|---|---|---|---|
| No. | | Surface type | curvature | Thickness | index | number | Reflection | constant |
| | | Spherical | Infinity | D1 | | | Refraction | |
| 1 | Stop | Spherical | Infinity | 12.0000 | | | Refraction | |
| | (STO) | | | | | | | |
| 2 | First lens | Aspherical | 65.9942 | 4.6000 | 1.547 | 56.30 | Refraction | 7.2081 |
| | (E1) | | | | | | | |
| 3 | | Spherical | Infinity | 0.0000 | | | Refraction | |
| 4 | Polarizer | Spherical | Infinity | 0.0640 | 1.533 | 50.00 | Refraction | |
| | (LP) | | | | | | | |
| 5 | Reflective | Spherical | Infinity | 0.0580 | 1.623 | 50.00 | Refraction | |
| | polarization | | | | | | | |
| | element | | | | | | | |
| | (RP) | | | | | | | |
| 6 | Quarter | Spherical | Infinity | 0.0510 | 1.533 | 50.00 | Refraction | |
| | wave | | | | | | | |
| | plate | | | | | | | |
| | (QWP) | | | | | | | |
| 7 | | Spherical | Infinity | D2 | | | Refraction | |
| 8 | Second | Aspherical | 321.4759 | 7.8646 | 1.547 | 56.30 | Refraction | 61.5282 |
| | lens (E2) | | | | | | | |
| 9 | Partially | Aspherical | −98.0978 | −7.8646 | 1.547 | 56.30 | Reflection | −16.3422 |
| | reflective | | | | | | | |
| | element | | | | | | | |
| | (BS) | | | | | | | |
| 10 | | Aspherical | 321.4759 | D3 | | | Refraction | 61.5282 |
| 11 | | Spherical | Infinity | −0.0510 | 1.533 | 50.00 | Refraction | |
| 12 | | Spherical | Infinity | 0.0510 | 1.533 | 50.00 | Reflection | |
| 13 | | Spherical | Infinity | D4 | | | Refraction | |
| 14 | Second | Aspherical | 321.4759 | 7.8646 | 1.547 | 56.30 | Refraction | 61.5282 |
| | lens (E2) | | | | | | | |
| 15 | | Aspherical | −98.0978 | 0.9944 | | | Refraction | −16.3422 |
| 16 | Image | Spherical | Infinity | 0.0000 | | | Refraction | |
| | plane | | | | | | | |
| | (IMG) | | | | | | | |

In the first embodiment, the first side surface of the first lens E1, the first side surface of the second lens E2 and the second side surface of the second lens E2 are aspherical, a surface type of which can be defined by, but is not limited to:

$$x = \frac{{ch}^{2}}{1 + \sqrt{1 - ( k + 1 ) {c}^{2} {h}^{2}}} + \sum {Aih}^{i} ; \qquad equation ( 1 )$$

where x is a sag indicating a distance to a vertex of the aspherical surface when the aspherical surface is at position with a height h in the optical axis direction; c is a paraxial curvature of the aspherical surface, and c=1/R, i.e., a reciprocal of the radius of curvature R in table 1; k is a conic constant; and Ai is a correction coefficient of the i^{th} order of the aspherical surface. Table 2 below gives high-order coefficients A4, A6, A8, A10, A12, A14, A16, A18 and A20 that can be used for the aspherical surfaces in the first embodiment.

TABLE 2

| Surface No. | 2 | 14 | 15 |
|---|---|---|---|
| A4 | 5.7627E−06 | 1.0713E−06 | −5.5872E−07 |
| A6 | −2.1717E−08 | −7.0202E−09 | −3.0160E−11 |
| A8 | 4.7206E−11 | −4.9994E−12 | −1.6485E−12 |
| A10 | −6.5645E−14 | −7.2744E−15 | 3.9211E−15 |
| A12 | 3.4908E−18 | 1.0634E−16 | 3.6823E−19 |
| A14 | 1.4424E−20 | −1.2206E−19 | 5.2133E−21 |
| A16 | 0.0000E+00 | 0.0000E+00 | 0.0000E+00 |
| A18 | 0.0000E+00 | 0.0000E+00 | 0.0000E+00 |
| A20 | 0.0000E+00 | 0.0000E+00 | 0.0000E+00 |

In this embodiment, the second element group is moved to cause a change in optical power of the vision system, which may enable a transition from the first state shown in FIG. 1 to the second state shown in FIG. 2. As shown in table 3, some structural parameters of the vision system are changed, where D1 represents a virtual image distance value of the vision system of this embodiment, and D2, D3 and D4 represent distances on the optical axis from the second side surface of the quarter wave plate to the first side surface of the second lens. Positive values of D1, D2, D3 and D4 indicate a direction from the first side to the second side, negative values of D1, D2, D3 and D4 indicate a direction from the second side to the first side, and D1, D2, D3 and D4 are all provided in mm.

TABLE 3

Parameter

| State | D1 | D2 | D3 | D4 |
|---|---|---|---|---|
| First state | 500.0000 | 6.3681 | −6.3681 | 6.3681 |
| Second state | −200.0000 | 4.2307 | −4.2307 | 4.2307 |

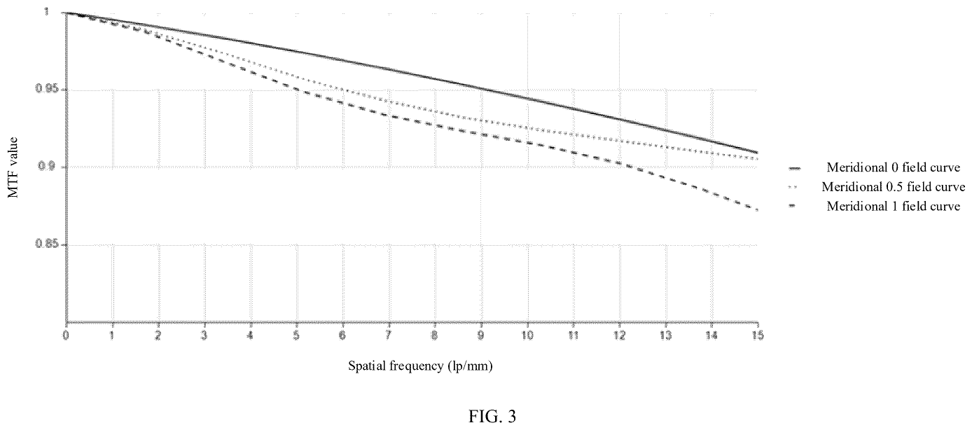

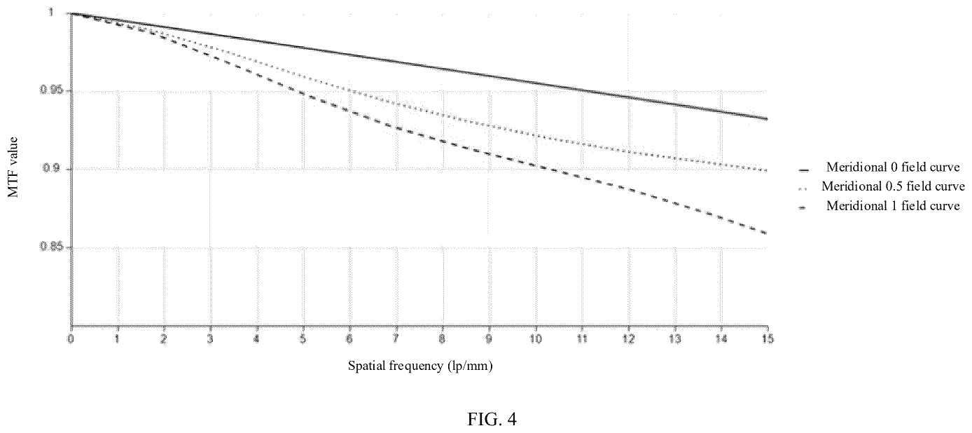

FIGS. 3 and 4 show MTF graphs of the vision system in the first embodiment in the first state and the second state, respectively, where the MTF value under the light of each field of view is above 0.85, exhibiting good imaging quality.

### Second Embodiment

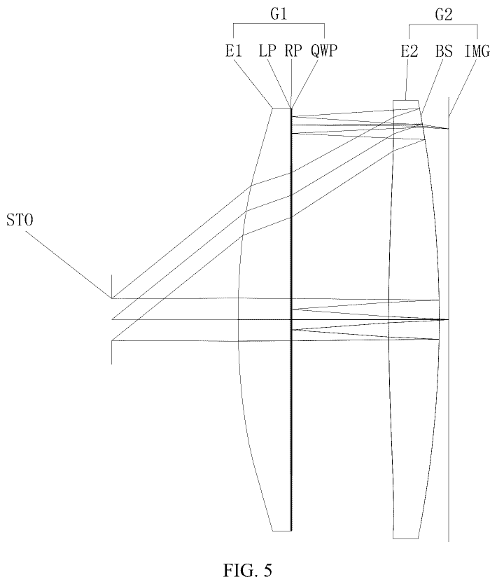

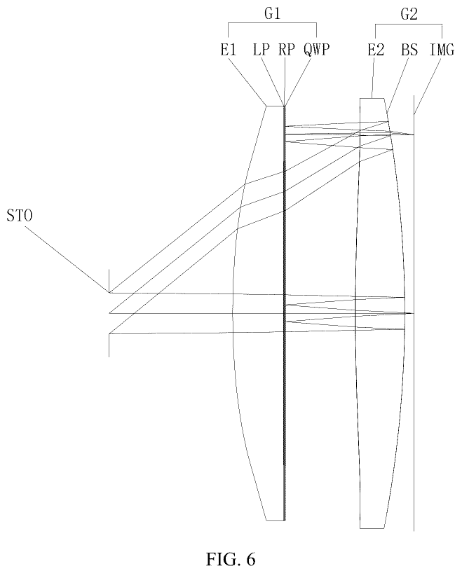

As shown in FIGS. 5 to 6, structures of a vision system according to the second embodiment of the present application in a first state and a second state are depicted, respectively.

As shown in FIGS. 5 to 6, the vision system sequentially includes, from a first side to a second side, a first element group G1 and a second element group G2. The first element group G1 includes a first lens E1, a polarizer LP, a reflective polarization element RP, and a quarter wave plate QWP, and the second element group G2 includes a second lens E2, a partially reflective element BS, and a display provided with an image plane IMG.

In this embodiment, the first lens has a positive power, a first side surface of the first lens is convex, and a second side surface of the first lens is planar, while the second lens has a positive power, a first side surface of the second lens is convex, and a second side surface of the second lens is convex. The vision system further has a stop STO between the first side and the first element group. A first side surface of the polarizer is at least partially attached to the second side surface of the first lens, a second side surface of the polarizer is attached to a first side surface of the reflective polarization element, a second side surface of the reflective polarization element is attached to a first side surface of the quarter wave plate, and a first side surface of the partially reflective element is at least partially attached to the second side surface of the second lens.

In this embodiment, light from the image plane IMG sequentially passes through the second lens E2 and the quarter wave plate QWP to the reflective polarization element RP, and after being reflected by the reflective polarization element RP, the light further passes through the quarter wave plate QWP and the second lens E2 sequentially to the partially reflective element BS on the second side surface of the second lens, where the light is reflected by the partially reflective element BS, and again passes through the second lens E2, the quarter wave plate QWP, the reflective polarization element RP, the polarizer LP, and the first lens E1 to be emitted.

In this embodiment, different from the first embodiment, the central thickness of the second lens on the optical axis is reduced, which not only reduces an optical path of the light in the second element group while maintaining the corresponding focal length, but also reduces the weight of the vision system, improves the comfort level of wearing for a user, and effectively reduce the chromatic aberration and aberration generated by off-axis light, thereby significantly improving the image quality.

Table 4 shows a table of basic structural parameters of the vision system in the second embodiment, in which radii of curvature, thicknesses/distances, and effective focal lengths are all provided in mm. In table 4, the light from the image plane IMG propagates from a plane 16 to a plane 1, and refraction/reflection indicates that the light is refracted or reflected by the corresponding numbered plane.

TABLE 4

| Surface | | Surface | Radius of | | Refractive | Abbe | Refraction/ | Conic |
|---|---|---|---|---|---|---|---|---|
| No. | | type | curvature | Thickness | index | number | Reflection | constant |
| | | Spherical | Infinity | D1 | | | Refraction | |
| 1 | Stop (STO) | Spherical | Infinity | 12.0000 | | | Refraction | |
| 2 | First lens | Aspherical | 78.7642 | 4.9520 | 1.547 | 56.30 | Refraction | 7.6617 |
| | (E1) | | | | | | | |
| 3 | | Spherical | Infinity | 0.0000 | | | Refraction | |
| 4 | Polarizer | Spherical | Infinity | 0.0500 | 1.492 | 50.00 | Refraction | |
| | (LP) | | | | | | | |
| 5 | Reflective | Spherical | Infinity | 0.0580 | 1.623 | 50.00 | Refraction | |
| | polarization | | | | | | | |
| | element | | | | | | | |
| | (RP) | | | | | | | |
| 6 | Quarter | Spherical | Infinity | 0.0510 | 1.533 | 50.00 | Refraction | |
| | wave plate | | | | | | | |
| | (QWP) | | | | | | | |
| 7 | | Spherical | Infinity | D2 | | | Refraction | |
| 8 | Second | Aspherical | 222.9471 | 4.8000 | 1.547 | 56.30 | Refraction | 84.0938 |
| | lens (E2) | | | | | | | |
| 9 | Partially | Aspherical | −106.5011 | −4.8000 | 1.547 | 56.30 | Reflection | −3.6290 |
| | reflective | | | | | | | |
| | element | | | | | | | |
| | (BS) | | | | | | | |
| 10 | | Aspherical | 222.9471 | D3 | | | Refraction | 84.0938 |
| 11 | | Spherical | Infinity | −0.0510 | 1.533 | 50.00 | Refraction | |
| 12 | | Spherical | Infinity | 0.0510 | 1.533 | 50.00 | Reflection | |
| 13 | | Spherical | Infinity | D4 | | | Refraction | |
| 14 | Second | Aspherical | 222.9471 | 4.8000 | 1.547 | 56.30 | Refraction | 84.0938 |
| | lens (E2) | | | | | | | |
| 15 | | Aspherical | −106.5011 | 0.8944 | | | Refraction | −3.6290 |
| 16 | Image | Spherical | Infinity | 0.0000 | | | Refraction | |
| | plane | | | | | | | |
| | (IMG) | | | | | | | |

Table 5 shows high-order coefficients A4, A6, A8, A10, A12, A14, A16, A18 and A20 that can be used for the aspherical lens surfaces in this embodiment, where the surface type of each aspherical surface can be defined by the equation (1) given in the first embodiment above. In this embodiment, the first side surface of the first lens, the first side surface of the second lens, and the second side surface of the second lens are all aspherical.

TABLE 5

| Surface No. | 2 | 14 | 15 |
|---|---|---|---|
| A4 | 9.0467E−06 | −2.3034E−06 | 3.3955E−07 |
| A6 | −3.2844E−08 | −4.8862E−09 | −9.2771E−10 |
| A8 | 7.2829E−11 | 8.3570E−12 | 0.0000E+00 |
| A10 | −7.4355E−14 | −4.6692E−14 | 0.0000E+00 |
| A12 | 0.0000E+00 | 9.7425E−17 | 0.0000E+00 |
| A14 | 0.0000E+00 | −9.1227E−20 | 0.0000E+00 |
| A16 | 0.0000E+00 | 0.0000E+00 | 0.0000E+00 |
| A18 | 0.0000E+00 | 0.0000E+00 | 0.0000E+00 |
| A20 | 0.0000E+00 | 0.0000E+00 | 0.0000E+00 |

In this embodiment, the second element group is moved to cause a change in optical power of the vision system, which may enable a transition from the first state shown in FIG. 5 to the second state shown in FIG. 6. As shown in table 6, some structural parameters of the vision system are changed, where D1 represents a virtual image distance value of the vision system of this embodiment, and D2, D3 and D4 represent distances on the optical axis from the second side surface of the quarter wave plate to the first side surface of the second lens. Positive values of D1, D2, D3 and D4 indicate a direction from the first side to the second side, negative values of D1, D2, D3 and D4 indicate a direction from the second side to the first side, and D1, D2, D3 and D4 are all provided in mm.

TABLE 6

Parameter

| State | D1 | D2 | D3 | D4 |
|---|---|---|---|---|
| First state | 500.0000 | 9.1947 | −9.1947 | 9.1947 |
| Second state | −200.0000 | 6.8251 | −6.8251 | 6.8251 |

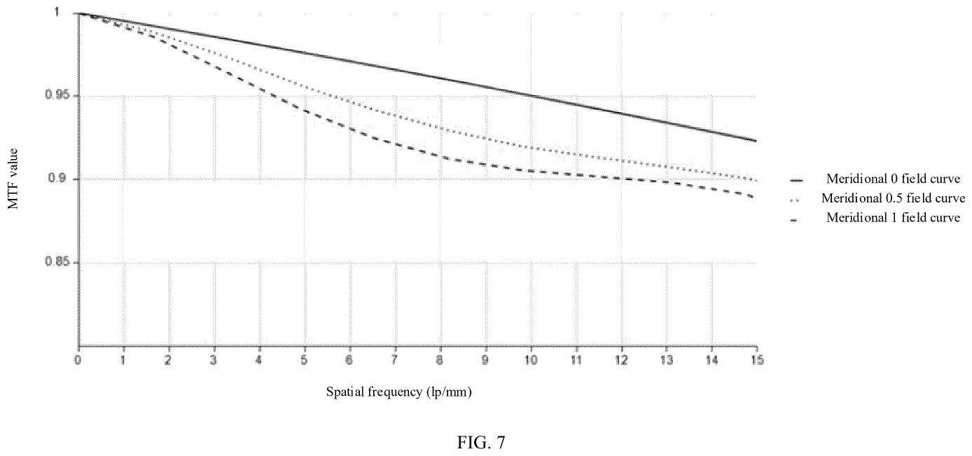

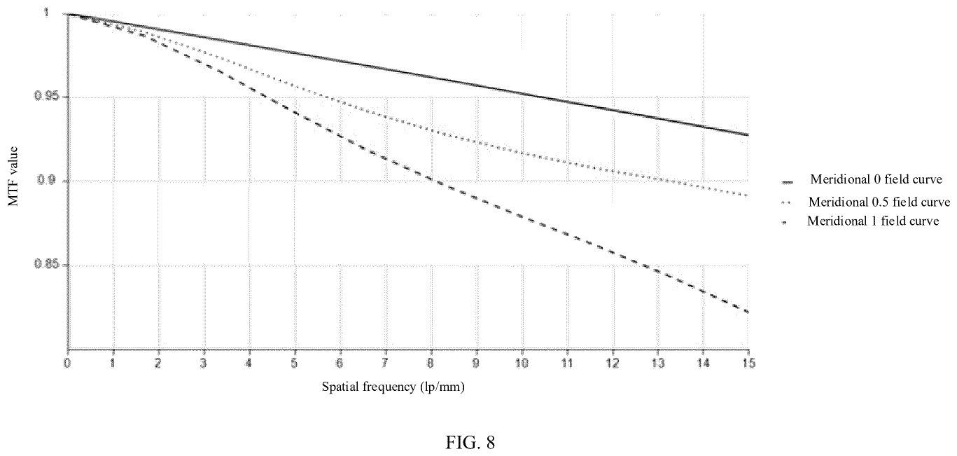

FIGS. 7 and 8 show MTF graphs of the vision system in the second embodiment in the first state and the second state, respectively, where the MTF value under the light of each field of view is above 0.8, exhibiting good imaging quality.

### Third Embodiment

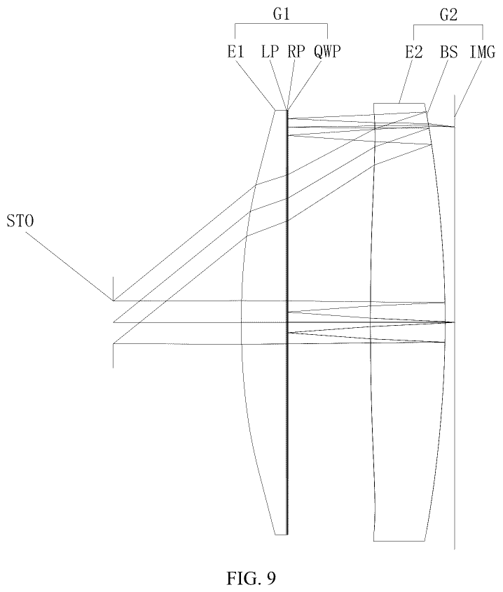

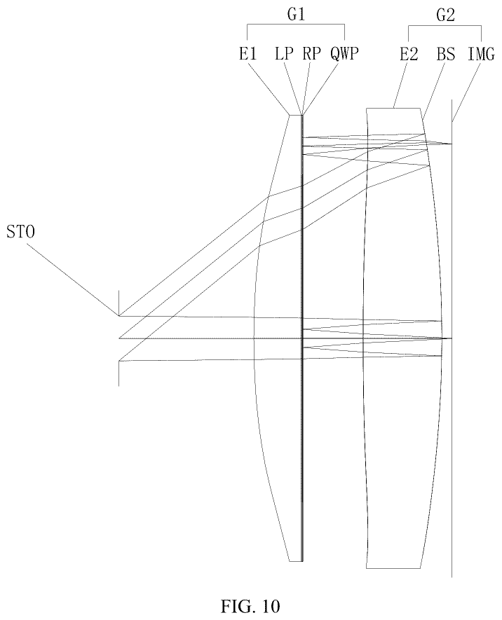

As shown in FIGS. 9 to 10, structures of a vision system according to the third embodiment of the present application in a first state and a second state are depicted, respectively.

As shown in FIGS. 9 to 10, the vision system sequentially includes, from a first side to a second side, a first element group G1 and a second element group G2. The first element group G1 includes a first lens E1, a polarizer LP, a reflective polarization element RP, and a quarter wave plate QWP, and the second element group G2 includes a second lens E2, a partially reflective element BS, and a display provided with an image plane IMG.

In this embodiment, the first lens has a positive power, a first side surface of the first lens is convex, and a second side surface of the first lens is planar, while the second lens has a positive power, a first side surface of the second lens is convex, and a second side surface of the second lens is convex. The vision system further has a stop STO between the first side and the first element group. A first side surface of the polarizer is at least partially attached to the second side surface of the first lens, a second side surface of the polarizer is attached to a first side surface of the reflective polarization element, a second side surface of the reflective polarization element is attached to a first side surface of the quarter wave plate, and a first side surface of the partially reflective element is at least partially attached to the second side surface of the second lens.

In this embodiment, light from the image plane IMG sequentially passes through the second lens E2 and the quarter wave plate QWP to the reflective polarization element RP, and after being reflected by the reflective polarization element RP, the light further passes through the quarter wave plate QWP and the second lens E2 sequentially to the partially reflective element BS on the second side surface of the second lens, where the light is reflected by the partially reflective element BS, and again passes through the second lens E2, the quarter wave plate QWP, the reflective polarization element RP, the polarizer LP, and the first lens E1 to be emitted.

In this embodiment, different from the first embodiment, the effective focal length of the second lens is increased, which increases the variation of the focal length fed back when the second element group of the vision system is moved along the optical axis, and further improves the zoom sensitivity of the vision system.

Table 7 shows a table of basic structural parameters of the vision system in the third embodiment, in which radii of curvature, thicknesses/distances, and effective focal lengths are all provided in mm. In table 7, the light from the image plane IMG propagates from a plane 16 to a plane 1, and refraction/reflection indicates that the light is refracted or reflected by the corresponding numbered plane.

TABLE 7

| Surface | | Surface | Radius of | | Refractive | Abbe | Refraction/ | Conic |
|---|---|---|---|---|---|---|---|---|
| No. | | type | curvature | Thickness | index | number | Reflection | constant |
| | | Spherical | Infinity | D1 | | | Refraction | |
| 1 | Stop (STO) | Spherical | Infinity | 12.0000 | | | Refraction | |
| 2 | First lens | Aspherical | 71.1426 | 4.2000 | 1.537 | 55.71 | Refraction | −1.6197 |
| | (E1) | | | | | | | |
| 3 | | Spherical | Infinity | 0.0000 | | | Refraction | |
| 4 | Polarizer | Spherical | Infinity | 0.0640 | 1.533 | 50.00 | Refraction | |
| | (LP) | | | | | | | |
| 5 | Reflective | Spherical | Infinity | 0.0580 | 1.623 | 50.00 | Refraction | |
| | polarization | | | | | | | |
| | element | | | | | | | |
| | (RP) | | | | | | | |
| 6 | Quarter | Spherical | Infinity | 0.0510 | 1.533 | 50.00 | Refraction | |
| | wave plate | | | | | | | |
| | (QWP) | | | | | | | |
| 7 | | Spherical | Infinity | D2 | | | Refraction | |
| 8 | Second lens | Aspherical | 350.4281 | 7.0000 | 1.537 | 55.71 | Refraction | −100.0000 |
| | (E2) | | | | | | | |
| 9 | Partially | Aspherical | −101.9363 | −7.0000 | 1.537 | 55.71 | Reflection | −28.0714 |
| | reflective | | | | | | | |
| | element | | | | | | | |
| | (BS) | | | | | | | |
| 10 | | Aspherical | 350.4281 | D3 | | | Refraction | −100.0000 |
| 11 | | Spherical | Infinity | −0.0510 | 1.533 | 50.00 | Refraction | |
| 12 | | Spherical | Infinity | 0.0510 | 1.533 | 50.00 | Reflection | |
| 13 | | Spherical | Infinity | D4 | | | Refraction | |
| 14 | Second lens | Aspherical | 350.4281 | 7.0000 | 1.537 | 55.71 | Refraction | −100.0000 |
| | (E2) | | | | | | | |
| 15 | | Aspherical | −101.9363 | 0.8944 | | | Refraction | −28.0714 |
| 16 | Image | Spherical | Infinity | 0.0000 | | | Refraction | |
| | plane | | | | | | | |
| | (IMG) | | | | | | | |

Table 8 shows high-order coefficients A4, A6, A8, A10, A12, A14, A16, A18 and A20 that can be used for the aspherical lens surfaces in this embodiment, where the surface type of each aspherical surface can be defined by the equation (1) given in the first embodiment above. In this embodiment, the first side surface of the first lens, the first side surface of the second lens, and the second side surface of the second lens are all aspherical.

TABLE 8

| Surface No. | 2 | 14 | 15 |
|---|---|---|---|
| A4 | 1.0188E−05 | 4.6598E−06 | −9.7263E−07 |
| A6 | −3.1447E−08 | −1.3777E−08 | 1.0075E−09 |
| A8 | 1.5279E−10 | −9.7518E−12 | −6.9702E−12 |
| A10 | −4.6364E−13 | 1.0531E−14 | −3.5101E−16 |
| A12 | 4.9453E−16 | 5.7019E−17 | 3.4244E−17 |
| A14 | 1.7319E−19 | −1.5646E−20 | −3.8789E−20 |
| A16 | 2.5324E−21 | −7.9100E−23 | −9.6257E−24 |
| A18 | −7.7360E−24 | −3.1643E−25 | −1.5650E−26 |
| A20 | 0.0000E+00 | 0.0000E+00 | 0.0000E+00 |

In this embodiment, the second element group is moved to cause a change in optical power of the vision system, which may enable a transition from the first state shown in FIG. 9 to the second state shown in FIG. 10. As shown in table 9, some structural parameters of the vision system are changed, where D1 represents a virtual image distance value of the vision system of this embodiment, and D2, D3 and D4 represent distances on the optical axis from the second side surface of the quarter wave plate to the first side surface of the second lens. Positive values of D1, D2, D3 and D4 indicate a direction from the first side to the second side, negative values of D1, D2, D3 and D4 indicate a direction from the second side to the first side, and D1, D2, D3 and D4 are all provided in mm.

TABLE 9

Parameter

| State | D1 | D2 | D3 | D4 |
|---|---|---|---|---|
| First state | 500.0000 | 7.7326 | −7.7326 | 7.7326 |
| Second state | −200.0000 | 5.3456 | −5.3456 | 5.3456 |

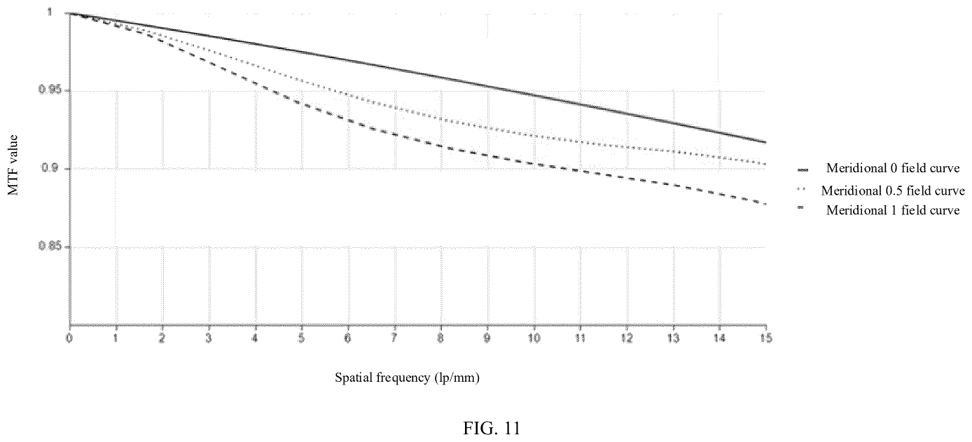

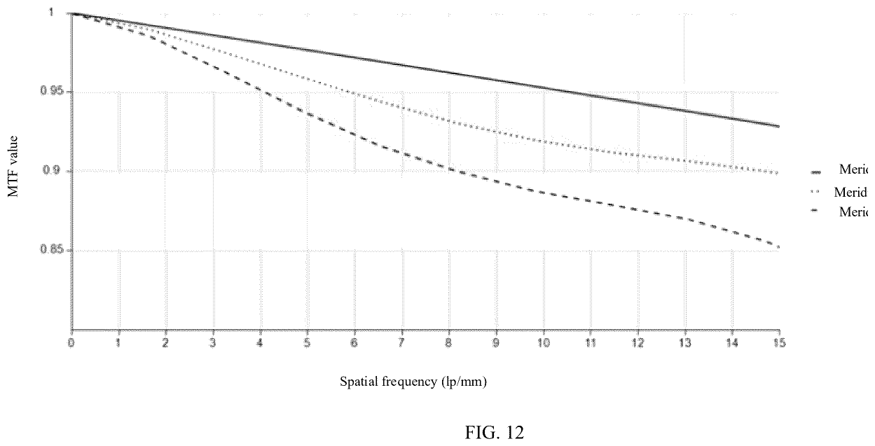

FIGS. 11 and 12 show MTF graphs of the vision system in the third embodiment in the first state and the second state, respectively, where the MTF value under the light of each field of view is above 0.84, exhibiting good imaging quality.

### Fourth Embodiment

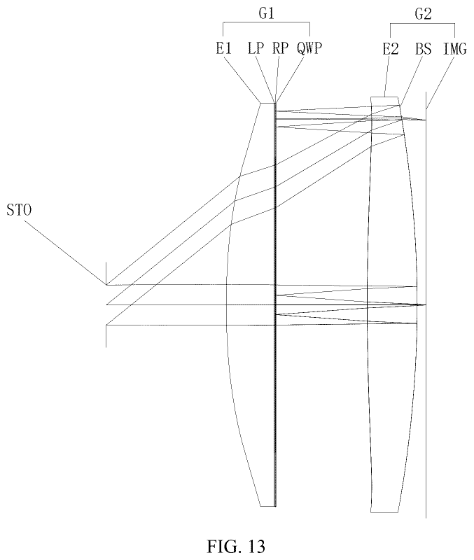

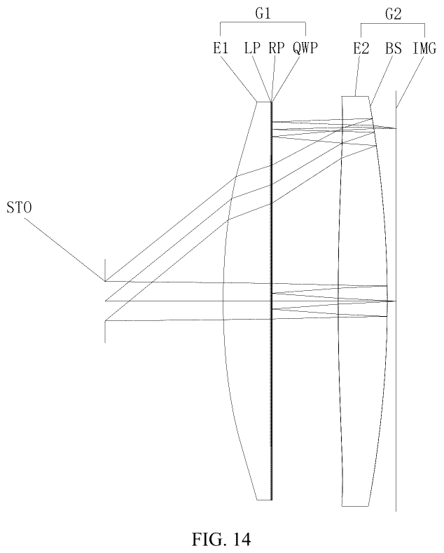

As shown in FIGS. 13 to 14, structures of a vision system according to the fourth embodiment of the present application in a first state and a second state are depicted, respectively.

As shown in FIGS. 13 to 14, the vision system sequentially includes, from a first side to a second side, a first element group G1 and a second element group G2. The first element group G1 includes a first lens E1, a polarizer LP, a reflective polarization element RP, and a quarter wave plate QWP, and the second element group G2 includes a second lens E2, a partially reflective element BS, and a display provided with an image plane IMG.

In this embodiment, the first lens has a positive power, a first side surface of the first lens is convex, and a second side surface of the first lens is planar, while the second lens has a positive power, a first side surface of the second lens is convex, and a second side surface of the second lens is convex. The vision system further has a stop STO between the first side and the first element group. A first side surface of the polarizer is at least partially attached to the second side surface of the first lens, a second side surface of the polarizer is attached to a first side surface of the reflective polarization element, a second side surface of the reflective polarization element is attached to a first side surface of the quarter wave plate, and a first side surface of the partially reflective element is at least partially attached to the second side surface of the second lens.

In this embodiment, light from the image plane IMG sequentially passes through the second lens E2 and the quarter wave plate QWP to the reflective polarization element RP, and after being reflected by the reflective polarization element RP, the light further passes through the quarter wave plate QWP and the second lens E2 sequentially to the partially reflective element BS on the second side surface of the second lens, where the light is reflected by the partially reflective element BS, and again passes through the second lens E2, the quarter wave plate QWP, the reflective polarization element RP, the polarizer LP, and the first lens E1 to be emitted.

In this embodiment, different from the first embodiment, the variation of the effective focal length of the vision system when the optical power of the vision system changes from +2 D to −5 D, and the moving distance of the second element group along the optical axis, are increased in the fourth embodiment, which indicates that the vision system can enable more sensitive zooming and a longer moving distance, thereby sufficiently satisfying the optical power change from +2 D to −5 D.

Table 10 shows a table of basic structural parameters of the vision system in the fourth embodiment, in which radii of curvature, thicknesses/distances, and effective focal lengths are all provided in mm. In table 10, the light from the image plane IMG propagates from a plane 16 to a plane 1, and refraction/reflection indicates that the light is refracted or reflected by the corresponding numbered plane.

TABLE 10

| Surface | | | Radius of | | Refractive | Abbe | Refraction/ | Conic |
|---|---|---|---|---|---|---|---|---|
| No. | | Surface type | curvature | Thickness | index | number | Reflection | constant |
| | | Spherical | Infinity | D1 | | | Refraction | |
| 1 | Stop (STO) | Spherical | Infinity | 12.0000 | | | Refraction | |
| 2 | First lens (E1) | Aspherical | 70.6481 | 4.8000 | 1.537 | 55.71 | Refraction | −0.9343 |
| 3 | | Spherical | Infinity | 0.0000 | | | Refraction | |
| 4 | Polarizer (LP) | Spherical | Infinity | 0.0640 | 1.533 | 50.00 | Refraction | |
| 5 | Reflective | Spherical | Infinity | 0.0580 | 1.623 | 50.00 | Refraction | |
| | polarization | | | | | | | |
| | element (RP) | | | | | | | |
| 6 | Quarter wave | Spherical | Infinity | 0.0510 | 1.533 | 50.00 | Refraction | |
| | plate (QWP) | | | | | | | |
| 7 | | Spherical | Infinity | D2 | | | Refraction | |
| 8 | Second lens | Aspherical | 253.0204 | 5.0000 | 1.547 | 56.30 | Refraction | −100.0000 |
| | (E2) | | | | | | | |
| 9 | Partially | Aspherical | −108.2113 | −5.0000 | 1.547 | 56.30 | Reflection | −35.6065 |
| | reflective | | | | | | | |
| | element (BS) | | | | | | | |
| 10 | | Aspherical | 253.0204 | D3 | | | Refraction | −100.0000 |
| 11 | | Spherical | Infinity | −0.0510 | 1.533 | 50.00 | Refraction | |
| 12 | | Spherical | Infinity | 0.0510 | 1.533 | 50.00 | Reflection | |
| 13 | | Spherical | Infinity | D4 | | | Refraction | |
| 14 | Second lens | Aspherical | 253.0204 | 5.0000 | 1.547 | 56.30 | Refraction | −100.0000 |
| | (E2) | | | | | | | |
| 15 | | Aspherical | −108.2113 | 0.8944 | | | Refraction | −35.6065 |
| 16 | Image plane | Spherical | Infinity | 0.0000 | | | Refraction | |
| | (IMG) | | | | | | | |

Table 11 shows high-order coefficients A4, A6, A8, A10, A12, A14, A16, A18 and A20 that can be used for the aspherical lens surfaces in this embodiment, where the surface type of each aspherical surface can be defined by the equation (1) given in the first embodiment above. In this embodiment, the first side surface of the first lens, the first side surface of the second lens, and the second side surface of the second lens are all aspherical.

TABLE 11

| Surface No. | 2 | 14 | 15 |
|---|---|---|---|
| A4 | 1.0152E−05 | −2.2953E−07 | −2.5978E−06 |
| A6 | −3.2035E−08 | −2.2797E−09 | 3.6164E−09 |
| A8 | 1.1517E−10 | −1.8925E−12 | −4.3926E−12 |
| A10 | −2.2197E−13 | 1.5310E−16 | −3.4671E−15 |
| A12 | 1.6576E−16 | 1.2649E−17 | 3.2475E−17 |
| A14 | −1.0360E−18 | −3.1790E−20 | −4.3547E−20 |
| A16 | 6.4920E−21 | 4.9020E−23 | −2.5157E−23 |
| A18 | −1.0759E−23 | −2.9389E−25 | 7.7032E−27 |
| A20 | 0.0000E+00 | 0.0000E+00 | 0.0000E+00 |

In this embodiment, the second element group is moved to cause a change in optical power of the vision system, which may enable a transition from the first state shown in FIG. 13 to the second state shown in FIG. 14. As shown in table 12, some structural parameters of the vision system are changed, where D1 represents a virtual image distance value of the vision system of this embodiment, and D2, D3 and D4 represent distances on the optical axis from the second side surface of the quarter wave plate to the first side surface of the second lens. Positive values of D1, D2, D3 and D4 indicate a direction from the first side to the second side, negative values of D1, D2, D3 and D4 indicate a direction from the second side to the first side, and D1, D2, D3 and D4 are all provided in mm.

TABLE 12

Parameter

| State | D1 | D2 | D3 | D4 |
|---|---|---|---|---|
| First state | 500.0000 | 9.1326 | −9.1326 | 9.1326 |
| Second state | −200.0000 | 6.6975 | −6.6975 | 6.6975 |

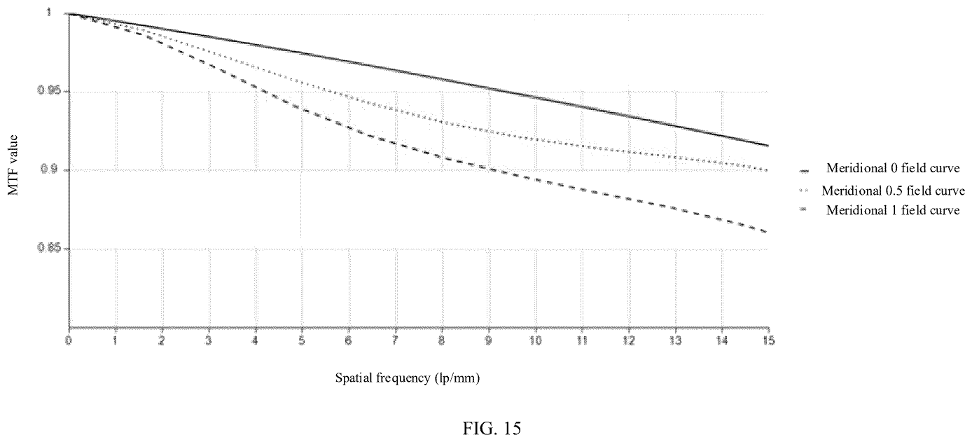

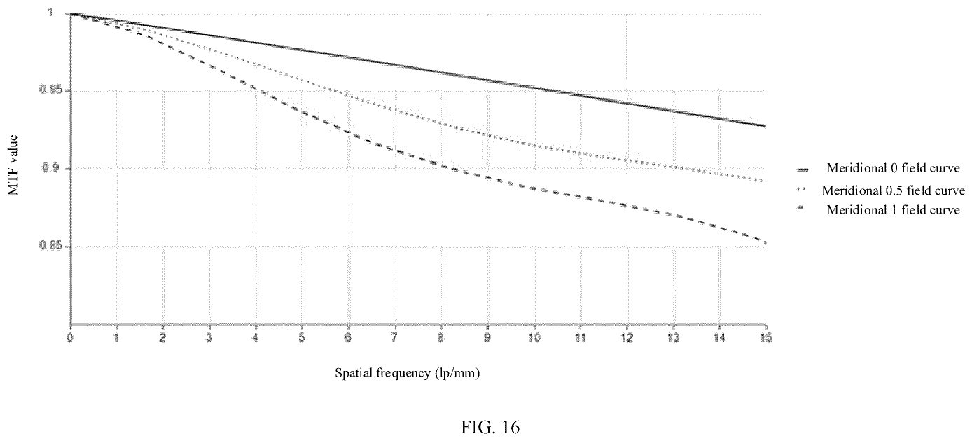

FIGS. 15 and 16 show MTF graphs of the vision system in the fourth embodiment in the first state and the second state, respectively, where the MTF value under the light of each field of view is above 0.84, exhibiting good imaging quality.

In summary, the first to fourth embodiments of the vision system respectively satisfy the relationship shown in table 13. Each embodiment of the vision system corresponds to the same value of the conditional expression in the first state and the second state.

TABLE 13

| | Embodiment | | | |
|---|---|---|---|---|
| Conditional expression | 1 | 2 | 3 | 4 |
| (R3 + R4)/fz | 1.85 | 0.81 | 1.88 | 1.10 |
| CT2/ΔL | 3.68 | 2.03 | 2.93 | 2.05 |
| (CT1 + CTL + CTR + CTQ)/Δf | 4.07 | 3.83 | 3.40 | 3.60 |
| R1/TDm | 3.47 | 4.12 | 3.72 | 3.70 |
| f2/(T12m + T12n) | 12.64 | 8.11 | 11.01 | 8.61 |
| f1/(fm + fn) | 2.39 | 2.73 | 2.49 | 2.45 |
| Δf/BFL | 1.18 | 1.49 | 1.44 | 1.54 |
| TDn/T12n | 3.83 | 2.40 | 3.03 | 2.43 |
| (f2/V2)/Δf | 2.09 | 1.76 | 2.06 | 1.79 |
| ΔL × (N2/N1) (mm) | 2.14 | 2.37 | 2.39 | 2.45 |
| TDn/(f1/V1) | 7.87 | 6.54 | 7.03 | 7.06 |
| (T12m + T12n)/EPD | 2.74 | 4.08 | 3.36 | 4.04 |
| ΔL × (R3/R4) (mm) | −7.00 | −4.96 | −8.21 | −5.69 |
| Δf × (f2/fz) (mm) | 1.35 | 1.23 | 1.43 | 1.46 |
| (CT1 + CT2)/T12m | 1.91 | 1.04 | 1.42 | 1.05 |

Table 14 shows the effective focal lengths and some parameters of the lenses and the element groups in the vision system in the first to fourth embodiments in mm.

TABLE 14

Embodiment

| Parameter | 1 | 2 | 3 | 4 |
|---|---|---|---|---|
| fm | 25.79 | 27.07 | 27.24 | 27.51 |
| fn | 24.61 | 25.74 | 25.95 | 26.13 |
| f1 | 120.64 | 143.98 | 132.46 | 131.54 |
| f2 | 138.31 | 132.43 | 147.82 | 139.23 |
| fz | 120.64 | 143.98 | 132.46 | 131.54 |
| EPD | 4.00 | 4.00 | 4.00 | 4.00 |
| TDm | 19.01 | 19.11 | 19.11 | 19.11 |
| TDn | 16.87 | 16.74 | 16.72 | 16.67 |
| T12m | 6.54 | 9.35 | 7.91 | 9.31 |
| T12n | 4.40 | 6.98 | 5.52 | 6.87 |
| ΔL | 2.14 | 2.37 | 2.39 | 2.44 |
| Δf | 1.17 | 1.33 | 1.29 | 1.38 |

Apparently, the embodiments described above are merely part, but not all, of the embodiments of the present disclosure. Based on the embodiments of the present disclosure, all other embodiments obtained by those of ordinary skill in the art without any creative effort fall within the protection scope of the present disclosure.

It should be noted that the terminology used herein is for the purpose of describing specific implementations only and is not intended to be limiting of exemplary implementations according to the present application. As used herein, the singular forms are intended to include the plural forms as well, and further, it should also be understood that when the terms “comprise” and/or “include” are used in this specification, they specify the presence of the stated features, steps, operations, devices, components, and/or combinations thereof, unless the context clearly indicates otherwise.

It should be noted that terms “first”, “second”, and the like in the description, claims and drawings of the present application are used for the purpose of distinguishing similar objects instead of indicating a specific order or sequence. It will be appreciated that the data so used may be interchanged under appropriate circumstances such that the implementations of the present application described here can be implemented, for example, in sequences other than those illustrated or described herein.

The descriptions above are merely preferred embodiments of the present disclosure, which are not used to limit the present disclosure. For those skilled in the art, the present disclosure may have various changes and variations. Any modification, equivalent replacement, improvement or the like made within the spirit and principle of the present disclosure shall be included in the protection scope of the present disclosure.

What is claimed is:

1. A vision system comprising:
a first element group comprising at least a first lens, a polarizer, a reflective polarization element, and a quarter wave plate which are sequentially positioned from a first side of the vision system to a second side opposite to the first side of the vision system along an optical axis, wherein the first lens has a positive power, a first side surface of the first lens is convex, and a second side surface of the first lens is planar; and
a second element group configured to be movable in a direction of the optical axis to approach or get away from the first element group, the second element group comprising at least a second lens, a partially reflective element, and a display which are sequentially positioned from the first side to the second side along the optical axis, wherein the second lens has a positive power, a first side surface of the second lens is convex, and a second side surface of the second lens is convex,
wherein the first element and the second element are sequentially positioned from the first side to the second side of the vision system,
wherein a radius of curvature R3 of the first side surface of the second lens, a radius of curvature R4 of the second side surface of the second lens, and a combined focal length fz of the first lens, the polarizer, the reflective polarization element and the quarter wave plate satisfy: 0.8<(R3+R4)/fz<1.9; and
a central thickness CT2 of the second lens on the optical axis, and a distance ΔL, travelled by the second element group along the optical axis when an optical power of the vision system is changed from +2 D to −5 D, satisfy: 2.0<CT2/ΔL<3.7.

2. The vision system of claim 1, wherein a central thickness CT1 of the first lens on the optical axis, a central thickness CTL of the polarizer on the optical axis, a central thickness CTR of the reflective polarization element on the optical axis, a central thickness CTQ of the quarter wave plate on the optical axis, and a variation Δf of an effective focal length of the vision system when the optical power of the vision system changes from +2 D to −5 D satisfy: 3.40≤(CT1+CTL+CTR+CTQ)/Δf≤4.07.

3. The vision system of claim 1, wherein a radius of curvature R1 of the first side surface of the first lens, and a distance TDm on the optical axis from the first side surface of the first lens to the second side surface of the second lens when the optical power of the vision system is +2 D satisfy: 3.47≤R1/TDm≤4.12.

4. The vision system of claim 1, wherein an effective focal length f2 of the second lens, a distance T12m on the optical axis from the second side surface of the first lens to the first side surface of the second lens when the optical power of the vision system is +2 D, and a distance T12n on the optical axis from the second side surface of the first lens to the first side surface of the second lens when the optical power of the vision system is −5 D satisfy: 8.11≤f2/(T12m+T12n)≤12.64.

5. The vision system of claim 1, wherein an effective focal length f1 of the first lens, an effective focal length fm of the vision system when the optical power of the vision system is +2 D, and an effective focal length fm of the vision system when the optical power of the vision system is −5 D satisfy: 2.35<f1/(fm+fn)<2.75.

6. The vision system of claim 1, wherein a variation Δf of an effective focal length of the vision system when the optical power of the vision system changes from +2 D to −5 D, and a distance BFL on the optical axis from the second side surface of the second lens to the display satisfy: 1.15<Δf/BFL<1.55.

7. The vision system of claim 1, wherein a distance TDn on the optical axis from the first side surface of the first lens to the second side surface of the second lens when the optical power of the vision system is −5 D, and a distance T12n on the optical axis from the second side surface of the first lens to the first side surface of the second lens when the optical power of the vision system is −5 D satisfy: 2.40≤TDn/T12n≤3.83.

8. The vision system of claim 1, wherein an effective focal length f2 of the second lens, an Abbe number V2 of the second lens, and a variation Δf of an effective focal length of the vision system when the optical power of the vision system changes from +2 D to −5 D satisfy: 1.76<(f2/V2)/Δf≤2.09.

9. The vision system of claim 1, wherein a distance ΔL travelled by the second element group along the optical axis when an optical power of the vision system is changed from +2 D to −5 D, a refractive index N2 of the second lens, and a refractive index N1 of the first lens satisfy: 2.14 mm≤ΔL×(N2/N1)≤2.45 mm.

10. The vision system of claim 1, wherein a distance TDn on the optical axis from the first side surface of the first lens to the second side surface of the second lens when the optical power of the vision system is −5 D, and an effective focal length f1 of the first lens, and an Abbe number V1 of the first lens satisfy: 6.54≤TDn/(f1/V1)≤7.87.

11. The vision system of claim 1, wherein a distance T12m on the optical axis from the second side surface of the first lens to the first side surface of the second lens when the optical power of the vision system is +2 D, a distance T12n on the optical axis from the second side surface of the first lens to the first side surface of the second lens when the optical power of the vision system is −5 D, and an entrance pupil diameter EPD of the vision system satisfy: 2.74≤(T12m+T12n)/EPD≤4.08.

12. The vision system of claim 1, wherein a distance ΔL travelled by the second element group along the optical axis when an optical power of the vision system is changed from +2 D to −5 D, a radius of curvature R3 of the first side surface of the second lens, and a radius of curvature R4 of the second side surface of the second lens satisfy: −8.21 mm≤ΔL×(R3/R4)≤−4.96 mm.

13. The vision system of claim 1, wherein a variation Δf of an effective focal length of the vision system when the optical power of the vision system changes from +2 D to −5 D, an effective focal length f2 of the second lens, and a combined focal length fz of the first lens, the polarizer, the reflective polarization element and the quarter wave plate satisfy: 1.2 mm<Δf×(f2/fz)<1.5 mm.

14. The vision system of claim 1, wherein a central thickness CT1 of the first lens on the optical axis, a central thickness CT2 of the second lens on the optical axis, and a distance T12m on the optical axis from the second side surface of the first lens to the first side surface of the second lens when the optical power of the vision system is +2 D satisfy: 1.04≤(CT1+CT2)/T12m≤1.91.
